(19) United States
(12) Patent Application Publication
(10) Pub. No.: US 2017/0286861 A1
(43) Pub. Date: Oct. 5, 2017

(54) STRUCTURED MACHINE LEARNING FRAMEWORK

(71) Applicants: Damian Kelly, Naas (IE); David Boundy, Bishopstown (IE); Hugh Carr, County Wicklow (IE)

(72) Inventors: Damian Kelly, Naas (IE); David Boundy, Bishopstown (IE); Hugh Carr, County Wicklow (IE)

(21) Appl. No.: 15/088,736

(22) Filed: Apr. 1, 2016

(51) Int. Cl. G06N 99/00; G06F 11/34; G06F 11/30; G06F 9/50

(52) U.S. Cl. CPC G06N 99/005; G06F 9/5011; G06F 11/3409; G06F 11/3024

(57) ABSTRACT

Disclosed is a computing device. The computing device can include a processor and a memory. The memory can store instructions that, when executed by the processor, can cause the processor to perform operations. The operations can comprise determining a computational burden for a component of an application, developing a cost model, and generating resource provisioning set points. The component of the application can execute at a specified performance level. The cost model can specify a cost to execute the component of the application over a range of performance levels. The range of performance levels can include the specified performance level. Each of the resource provisioning set points can indicate a quantity of compute nodes assigned for each phase of the component of the application. The quantity of compute nodes can be based on the specified performance level and the cost to execute the component of the application.

### TECHNICAL FIELD

Embodiments described generally herein relate to machine learning. More specifically, embodiments described generally herein relate to dynamic adjustment of resources in a machine learning application framework.

### BACKGROUND

The Internet of Things (IoT) is the network of physical objects devices, vehicles, buildings and other items embedded with electronics, software, sensors, and network connectivity—that enables these objects to collect and exchange data. By 2020 it is estimated that the IoT will consist of almost 50 billion objects. With the accelerated emergence of the IoT, executing collaborative large-scale machine learning applications with data from IoT devices is becoming a computationally prohibitive task. As more IoT devices are introduced, the machine learning task complexity and computational requirements can increase exponentially.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a schematic of an architecture in accordance with some embodiments.

FIG. 2 illustrates an example of a machine learning application framework in accordance with some embodiments.

FIG. 3 illustrates an example system for modeling resource requirements in accordance with some embodiments.

FIGS. 4A and 4B illustrate examples of plots used to visualize performance in accordance with some embodiments.

FIGS. 5A and 5B illustrate an example of a cascading machine learning application framework in accordance with some embodiments.

FIG. 6 illustrates a block diagram of a computing device in accordance with some embodiments.

FIG. 7 illustrates an example method in accordance with some embodiments.

### DETAILED DESCRIPTION

The systems and methods disclosed herein include a machine learning application framework that can be structured in such a way that machine learning applications can be implemented and autonomously parallelized with no or minimal intervention. As disclosed herein, a developer can implement plugins to produce functionality at particular processing stages. The computational burden for a particular application part and sub-part can be empirically or theoretically determined and the financial cost for any specified level of performance can be modelled and reported to users or external systems. Resource provisioning set points can be generated. The resource provisioning set points can dictate quantities of compute nodes to be assigned to particular phases of an application framework. The quantities of the compute nodes can be assigned such that computation bottlenecks can be minimized while maintaining specified levels of performance and financial budget constraints for a particular application or application subpart. The resource provisioning set points can be control signals that can be based on, for example, historical resource requirements combined with available operational constraints (which can be provided by user input), upon which dynamic adjustments to resources or compute nodes in the machine learning application framework can be made.

As disclosed herein, a framework structure can be utilized and applied to machine learning tasks. The framework structure can allow for a developer to implement functionality in the form of plugins conforming to a prescribed structure. The use of the plugins can permit ease of parallelization while maintaining performance level guarantees. While the systems and methods described herein are described with reference to the IoT device machine learning, they can be equally applied to any machine learning application that can incorporate data from any number of sources and produce results that can be consumed by any number of external data sinks.

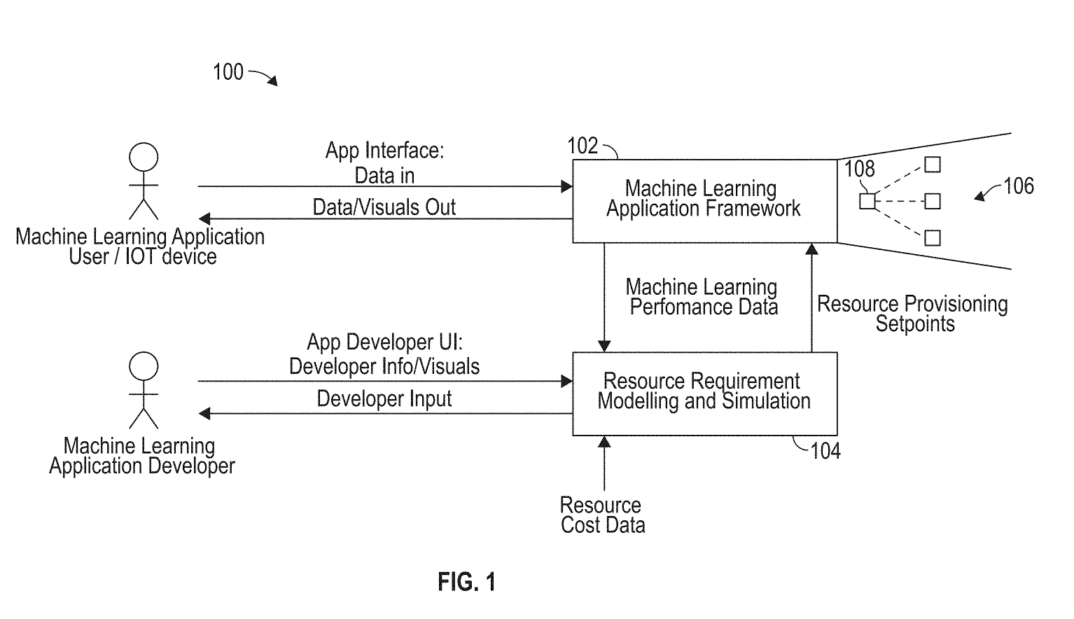

Turning now to the figures, FIG. 1 illustrates example architecture 100. The architecture 100 can include a machine learning application framework and a resource requirement modelling and simulation component 104. The machine learning application framework 102 can include delegated constituent operations across a varying number of compute nodes 106. The varying number of compute nodes 106 can be defined by resource provisioning set point signals distributed by a computing device 108. The compute nodes 106 can be physical compute nodes, virtual compute nodes, or a combination of physical and virtual compute nodes. The physical and virtual compute nodes can include a number of physical or virtual computational resources that can be assigned tasks or stages of the machine learning application framework 102.

As disclosed herein, the number of physical or virtual computational resources assigned to each stage of the machine learning application framework can be dynamically modified. The modifications can occur without interrupting machine learning operation fidelity. For example, control signals or information upon which dynamic adjustments to resources or compute nodes 106 assigned to the framework are made can be modified.

The resource requirement modelling and simulation component 104 can receive and utilize machine learning performance data to enable the generation of a model of the relationship between the resources utilized at each framework stage. In addition, the resource requirement modelling and simulation component 104 can utilize the machine learning performance data to generate a model of the relationship between the resources utilized and the application execution performance.

The costs for computational nodes in the presence of, for example, short-term spot pricing or long-term rental rates can be incorporated into the various models to enable the estimation of the cost per framework execution or cost per period of framework availability. For example, the various models can utilize costs data to estimate a cost per hour, per day, or per month for using the machine learning application framework 102. As discussed herein, an application developer or application user can utilize the models and generate plots of the costs as functions of various variables. The plots can allow the application developer or application user to visually or programmatically review the relationships between financial costs, number of computational resources, execution time, machine learning application size, etc. to specify the number of compute nodes they require.

For easier user interaction, the user can merely specify limits on financial costs, execution time, or computational nodes they are willing to bare and the resource provisioning set points can be optimized to minimize costs for the user while maintaining the specified limits. For example, the user can view the plot and select a number of compute nodes consistent with a budget constraint. In another example, the user can set a maximum time limit, or execution time, to perform a task and determine the cost to have the task performed within the maximum time limit. For instance, the user may want the results within 24 hours. Using the systems and methods disclosed herein, the user can determine that to have to results in 24 hours it will cost X dollars. However, if the user can wait 48 hours, the cost may be Y dollars. As a result, the user can make an educated decision about time vs. cost.

Machine learning web servers can execute machine learning applications specified in a user-defined engine, and run batch processing applications across numerous nodes. The systems and methods disclosed herein can enable batch processing with finer grained control over the individual processing steps. In addition, the systems and methods disclosed herein can allow for near-real-time processing to take place on the same framework. Near-real-time can be achieved by pushing arriving data into a proceeding data processing subsystems as soon as the data arrives. The data can be propagated to a final stage of the processing pipeline as soon as possible. Therefore, the developer can have the option to either immediately process the data in subsequent processing blocks without delay or queue arriving data at subsequent processing blocks until specific criteria are met. For example, by immediately propagating the arriving data, the application can utilize the data in subsequent processing blocks without having to wait for a sufficient quantity of data to arrive, a particular time criterion to be satisfied, a particular condition on an individual piece of data to be satisfied.

Current systems utilize a mechanism for aggregating data over time in an eventually consistent fashion. However, the systems and methods disclosed herein can allow for real-time, or near real-time, batch processing on immediately-consistent data, which can be critical for statistically rigorous machine learning applications. For example, generating an optimized device activation schedule for a community of IoT devices can require up-to-date data from all relevant devices at the time of optimization. If any data from devices are not immediately consistent, the result of the optimization can be invalid as the data, and thus optimization, does not include up-to-date knowledge of the state of all devices being optimized.

Furthermore, current systems require an algorithm implementer to manually trigger a machine learning training phase either via a GUI or command line. However, the systems and method disclosed herein can enable the learning phase to be triggered automatically using logic of the plugins created by the developer. The learning phase can be used to automatically generate control signals (e.g. resource provisioning set points) upon which dynamic adjustments to resources and compute nodes assigned to the framework can be made.

The systems and methods disclosed herein can allow for the automatic scaling of the infrastructure assigned to each stage of the machine learning application framework 102. Furthermore, the visual representations can enable developers to specify infrastructure requirements by using machine learning algorithms to estimate the optimal resource requirements. For example, developers can choose a computational time or budget requirements or limits and the computational resource requirements can be calculated and provisioned on the machine learning application framework 102.

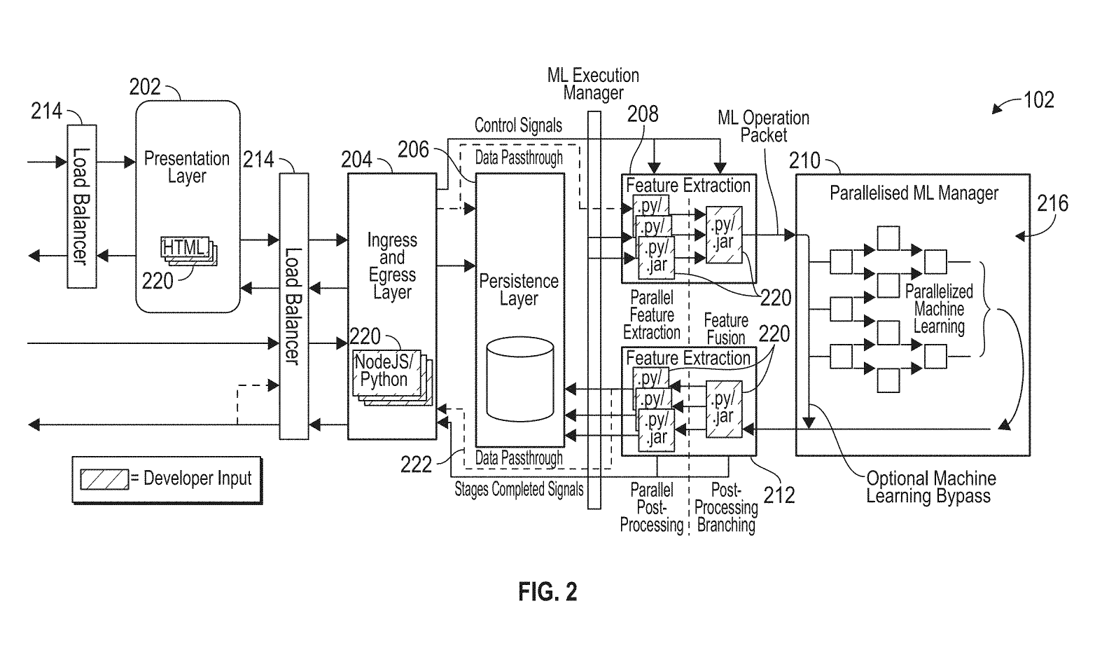

FIG. 2 illustrates an example of the machine learning application framework 102. The machine learning framework 102 can include a presentation layer 202, an ingress and egress layer 204, a persistence layer 206, a feature extraction component 208, a parallelized machine learning component 210, and a post-processing component 212. The machine learning application framework 102 can also include load balancers 214. The feature extraction component 208 can include feature fusion and parallel feature extraction. The post processing 212 can include parallel post-processing and post-processing branching. The parallelized machine learning component 210 can include compute nodes 216. As shown in FIG. 2, the various components of the machine learning application framework 102 can include plugins 220. During operation, the machine learning application framework 102 can be responsible for executing machine learning applications according to the plugins 220.

As disclosed herein, an application framework can be applied to a majority of machine learning applications such that any developer who implements their functionality in the form of plugins conforming to the structure of the framework can avail of easy parallelization, identification of performance bottlenecks, and performance level guarantees. To implement a machine learning application, a developer can create a minimal set of plugins for specific points in the framework (e.g., the plugins 220). Particular machine learning application implementations may not require the full utilization of each stage. Thus, if particular plugins are not created, then an appropriate default behavior for that level can be implemented. For example, if a plugin for the presentation layer 202 is not created, then the presentation layer 202 can implement a default behavior. The default behavior can include a default resource allocation.

In the example shown in FIG. 2, the feature fusion block of feature extraction 208 can be responsible for merging, or fusing, several independently processed streams of data before feeding the merged dataset into the parallelized machine learning component 216. Conversely, the post-processing branching operation of the post-processing component 212 can take the aggregate result from the parallelized machine learning component 216 and split the data into independently process-able blocks. The number of formats of the process-able blocks can depend on the particular machine learning application.

The parallel feature extraction block of the feature extraction component 208 and the parallel post-processing block of the post-processing component 212 can be used for parallel processing of data streams which have no cross dependencies. For example, each parallel feature extraction block can extract the frequency components from time series data of an individual device, optionally fetch relevant data from auxiliary sources (e.g., weather, traffic, noise, etc.) and forward the combined results for that device to the feature fusion block of the feature extraction component 208. Similarly, the parallel post-processing blocks of post-processing component 212 can take independent segments of data from the output of the machine learning component 216, and perform operations on the data, which does not require cross-dependencies between the individual segments.

The feature extraction component 208, post-processing component 212, including the feature fusion and post-processing branching blocks, can have the ability to fetch data from any number of sources necessary for their respective operations (e.g., real-time data streams via data pass-through route 222, the persistence layer 206, auxiliary databases (not shown), online sources (not shown), etc. While various data sources are contemplated, no particular data source is mandatory for the successful functioning of the machine learning framework 102.

Machine learning operations that can be implemented using the systems and methods disclosed herein include, but are not limited to, optimization, feature extraction/fusion, predictive analytics, clustering, and classification. Any combination of these operations can be cascaded together to produce the desired functionality. Furthermore, any of the feature extraction or post-processing blocks can utilize a single threaded form of any of the machine learning operations necessary to complete their application specific tasks.

Logic in the ingress and egress layer 204 can dictate what actions occur when data arrives from the outside world. This can include persistence of data, direct passing of data to parallel feature extraction blocks, emission of control signals, etc. In addition, the logic in the ingress and egress layer 204 can dictate what to do when parallel post-processed operations are finished. This can include emitting data to requisite devices, triggering the execution of another machine learning applications, etc.

Consistent with embodiments disclosed herein, real-time, or near real-time, mode can be supported by feeding data directly from ingress into feature extraction component 208, passing straight through machine learning component 210, and feeding directly from post-processing component 212 to egress. In addition, batch mode can be supported by populating a database and signaling the parallel feature extraction or feature fusion blocks of the feature extraction component 208 to start via a machine learning execution manager. Returning signals from the machine learning execution manager can be labelled “present” to finish a cycle or labeled with a different name to feed into another application. Addition and removal of nodes at each extensible stage can happen online according to a time-varying resource provisioning set points.

As disclosed herein, the extensible stages of the machine learning framework 102 and their resource allocation can directly impact execution time. Other stages which have their computational resource allocation defined by resource provisioning set points can include the presentation layer 202, the ingress and egress layer 204, and the persistence layer 206. The performance model can encompass relationships between the various components and thus allow appropriate scaling at all layers and components.

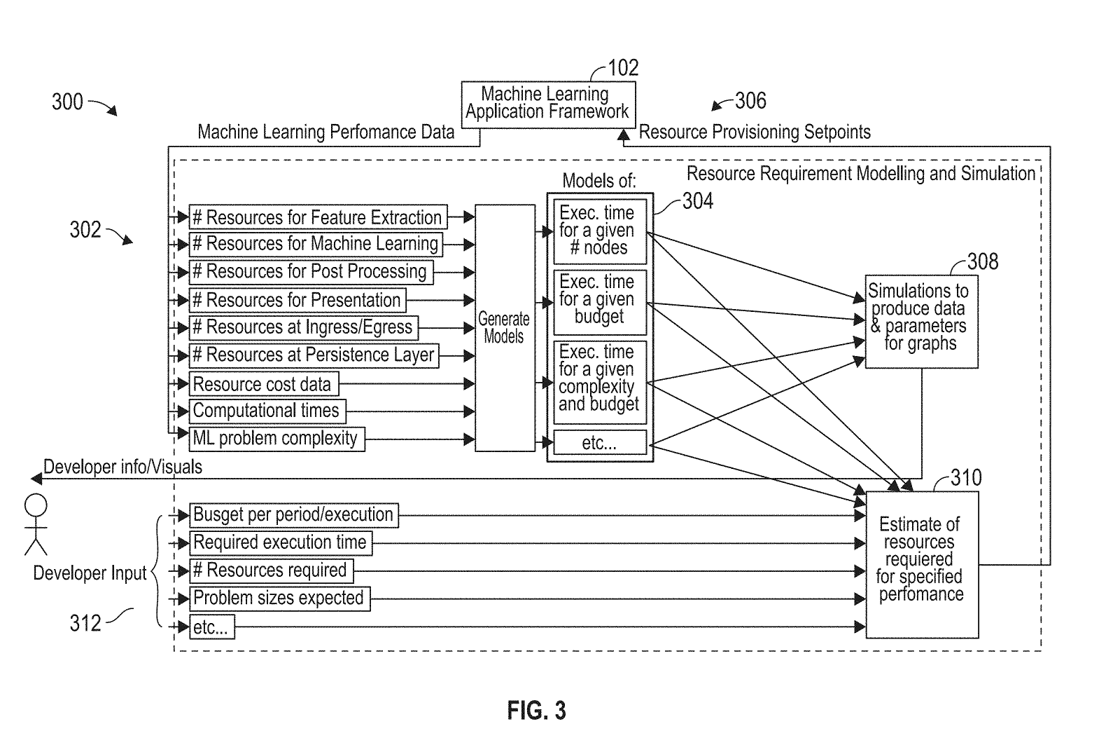

FIG. 3 illustrates an example system 300 for modeling resource requirements to achieve a particular machine learning framework performance. The scalable machine learning application framework can be constructed such that a majority of machine learning applications can be implemented on a generic structure and the number of computation resources allocated to each stage of the process can be dynamically adjusted at run-time. To ensure desired performance requirements can be met, a model describing the performance of the framework in response to a varying amount of resources can be generated. Using the model, the amount of resources can be tuned to optimally achieve the performance requirements.

As shown in FIG. 3, data 302 describing the performance of the system 300 under different computation resource allocation scenarios can be received from the machine learning application framework 102 via streaming data or from logs. The data 302 can include the number of resources for each of the components of the machine learning application framework 102. For example, a number of resources for feature extraction, post-processing, ingress and egress, computational costs, computational times, etc. can be received.

Using the various data 302, models 304 for the relationship between the various scenarios and the system 300 performance can be generated. For example, the system 300 can model the non-linear relationship between the amount of resources allocated to each framework stage (and the resulting resource costs) and the algorithm execution time. The models 304 can be used to generate graphs or other visual indicators and minimal data to allow a developer to (manually or programmatically) choose particular resource requirements and allow the automatic optimization of resource provisioning set points to achieve the requirements. If no performance or cost preferences are provided, the models 304 can alternatively be used to optimally balance resources across framework stages in the presence of finite computational resources.

The resource provisioning set points can be sent to the machine learning application framework 102, which can dynamically modify the number of resources at each framework stage to achieve specified performance levels. As the system 300 and the machine learning application framework 102 operate, more performance data can be generated, which can contribute to the recurring evolution of more accurate performance models.

In addition, individual models can be generated for individual application IDs and framework IDs. When insufficient data exists to generate a sufficiently detailed individual model, the system 300 can take default behavior from components of other empirical models derived from other framework instances or from mathematical models to form complete models. The system 300 can learn performance of several frameworks and total applications running on the same framework at the same time and can ensure specified performance for all users and maximize utility to all users according to a service level agreement (SLA).

The models 304 can also be used for simulations 308. The simulations 308 can be used to produce data and parameter estimates that can be used to generate plots or other visual aids. Use of the visual aids and the models 304 can be used to generate estimates 310 of resource requirements for specific performance. The generated estimates 310 can use user inputs 312 to provide feedback to a user and in generating the resource provisioning set points 306.

As discussed herein, the machine learning application framework 102 can dynamically utilize resources as they are allocated to particular stages by a resource requirement modeler and if performance requirements are not stipulated, the modeler can automatically balance the resources across all stages to maximize performance. If a user chooses, he or she can take a more direct role in the resource allocation by interacting with a developer dashboard. For example, a graphical user interface (GUI) can be used to provide performance requirements.

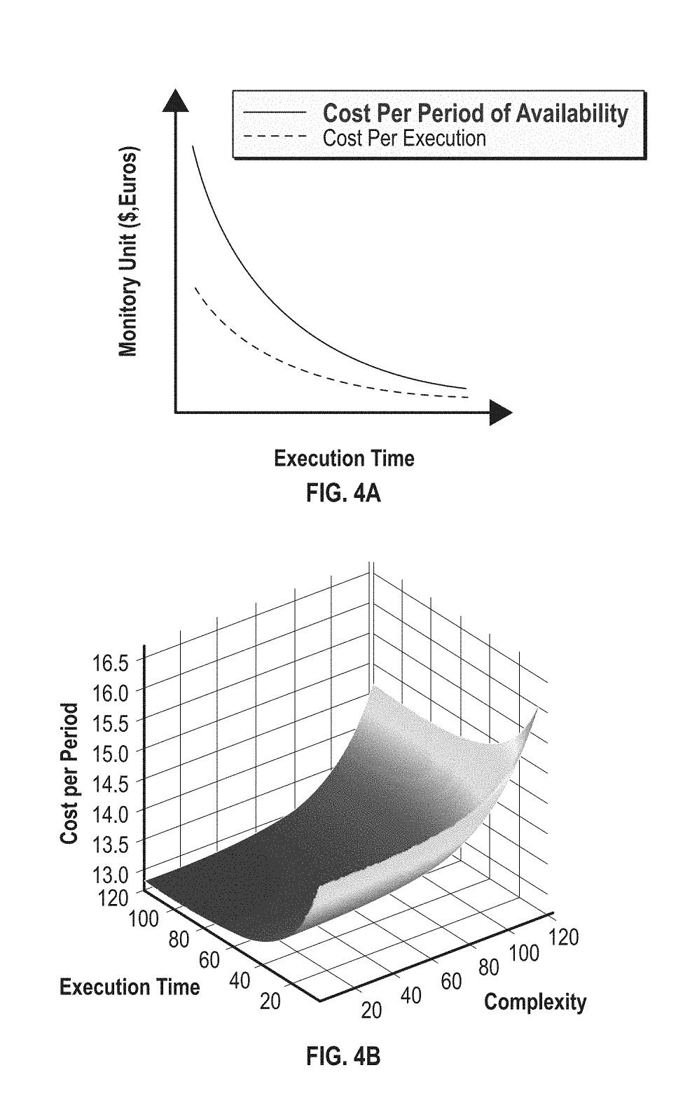

The GUI can provide graphs or structured data which describes the effect of changing the configuration of the machine learning framework 102. The graphs can generally describe the relationship between execution time and cost of execution and cost of day of availability (see FIG. 4A). Using the graphs can allow the user to choose the tradeoff between budget constraints and algorithm execution time requirements. For example, a user can have a budget constraint of X Euros per period of availability and can thus visually determine an execution time. If the execution time is greater than the user can bare, then the user can make a determination to increase his or her budget.

While FIG. 4A shows execution time and costs, other variables can be chosen for comparison. For example, other variables can include, but are not limited to, a number of compute nodes assigned, a ratio of compute nodes assigned to machine learning vs other stages, complexity of the machine learning problem being solved (specified in an algorithm-specific quantity), computational resource provider, etc. With the input, the system 300 can formalize the resources necessary to minimize the computational time or keep the computational time within an application/user-specified bound.

In addition, the graphs can allow for visualization of the impact of numerous variables on the cost of running applications. For example, as shown in FIG. 4B, the cost for running the machine learning framework 102 for a period of time (e.g. a day) for a chosen execution time and for a given task complexity can be plotted. As a result, a user can enter the complexity and adjust the execution time until an acceptable cost s found. Once performance requirements are chosen for one or more parameters, this data can be sent to the system 300 (e.g., a resource requirement modeler) and the machine learning application framework 102 resources can be managed as described herein at least with regards to FIG. 3.

In addition to cost data, the GUI can allow for visualization of which components of the machine learning application framework 102 are responsible for what proportions of the application execution time. In addition, the visualizations can allow a developer to identify bottlenecks and allow the developer to quantify the effect of refactoring code to perform more operations in parallelized blocks. Thus, the developer can identify and exploit opportunities to further parallelize code.

Referring back to FIG. 2, the machine learning framework application framework 102 can be used for a machine learning application for the collaborative optimization controlling numerous IoT devices based on the known state of all devices.

As shown in FIG. 2, up-to-date state data from all devices or a subset of devices at the time of optimization can be utilized. Thus, state data updates can arrive from the IoT device via the ingress and egress layer 204 and can be cached in the persistence layer 206, with immediate consistency across all persistence layer 206 nodes.

When the machine learning application is triggered by logic in the ingress and egress layer 204, all up to-date state data for the IoT devices can be read from the persistence layer 206 into the parallel feature extraction components of the feature extraction components 208. Each individual device can be processed in parallel in the parallel feature extraction blocks of the feature extraction components 208 to translate the device's state data into knowledge about an environment in which the device resides. The device's state data can in-turn be translated into optimization feature sets for that device. These individual features can then be passed onto the feature fusion blocks of the feature extraction components 208 which can aggregate all arriving optimization features from individual devices into a full feature set for the optimization.

When the feature fusion block has aggregated the features for all devices, it can trigger a run of the parallelized machine learning component 210, which in this example can be a large-scale parallel evolutionary optimization algorithm. The result of this optimization can be a set of optimal features that do not yet have a direct correspondence to the real-world settings. The feature fusion block can split up these features into segments that can be independently processed, which in this application can be the segmenting of the features according to the device to which they belong. The individual device features can then be fed into the parallel post-processing components 212, which can process and store the data as appropriate to the use-case. In this case, this can involve translating the segmented optimized features for the individual device into configurations and control signals for that device. The data for each device can be independently stored by a parallel post-processing component 212 and the stages completed signal can be emitted for that block. The ingress and egress layer 204 can know how many stages completed signals to expect and can emit either the optimized device controls to the target devices as soon as each device has finished processing or in a batch when all devices are finished processing.

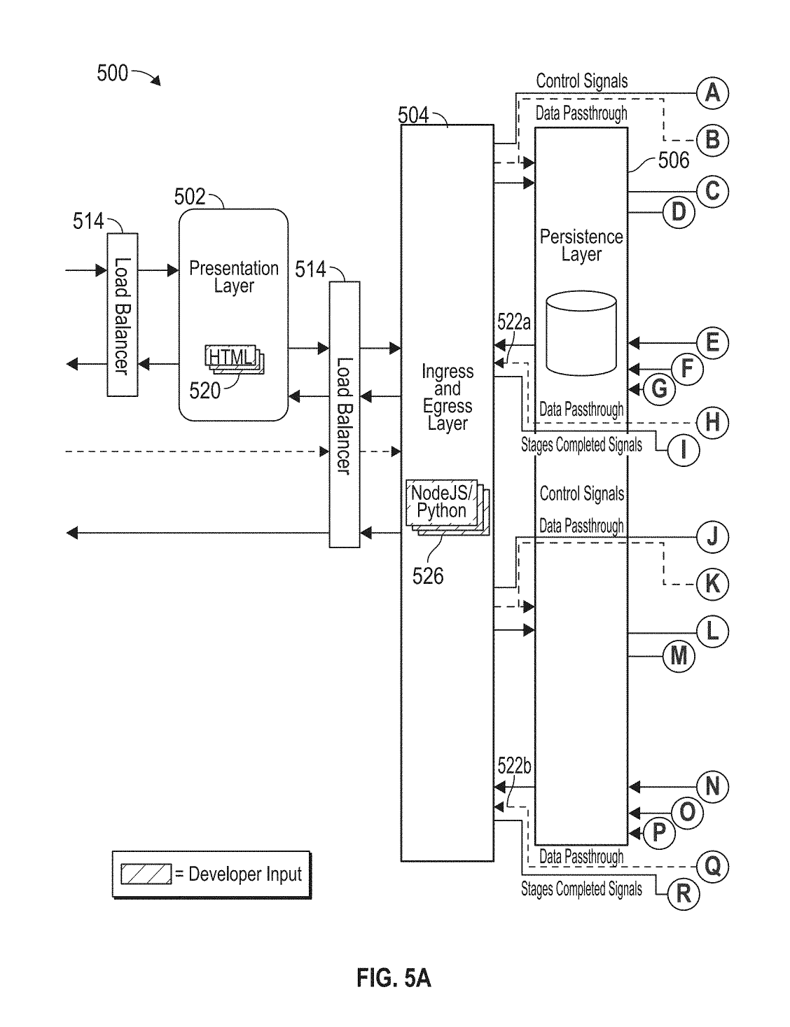

FIGS. 5A and 5B show an example of a cascading machine learning application framework 500 in accordance with some embodiments. As shown in FIGS. 5A and 5B, one or more instances of neural network frameworks 530a and 530b (collectively 530) can be cascaded and pipelined with different chosen machine learning blocks.

The neural networks 530 can be supervised machine learning techniques that can be used for regression or classification tasks. Thus, they can utilize a statistically rigorous training phase on historical data and an estimation phase on previously unseen data. The estimation phase can utilize the neural network structure calculated in the training phase, which can sometimes be run in batch mode.

As shown in FIGS. 5A and 5B, the neural network training framework 530a can exploit parallelization. This can be useful as a neural network training phase may require the evaluation of numerous candidate structures for predictive efficacy and could also employ a deep learning neural network. This can result in the need for a large neural network structure and a large training dataset. The parallel feature extraction components 508 can be used to remove spurious data, interpolate missing data, and acquire any necessary auxiliary data depending on the target variable being estimated. The feature fusion block of the feature extraction component 508 can aggregate all such data into one dataset and normalize the data before feeding into the neural network optimization, which can determine the optimal neural network structure and parameters for the available data. The optimal neural network structure and parameters can then be stored in the persistence layer 506 for use by the neural network estimation framework 530b, without significant post-processing parallelization.

A neural network estimation phase can utilize the optimal network structure and parameters determined in the training phase to predict target variables that can be based on input features and equivalent feature extraction techniques utilized in the neural network training framework 530a. The parallelized nature of the neural network estimation phase means that it can represent the entire structure of a large neural network across the available nodes. This can enable the near-real-time transformation of input features to target variables through the neural network even when a deep neural network is employed.

While FIGS. 5A and 5B depicts separate frameworks for simplicity, several framework instances and entire applications can be run in parallel on the same hardware. The resource requirement modeler can be responsible for specifying the amount of resources required to provide the necessary performance to all application developers utilizing the same underlying compute infrastructure.

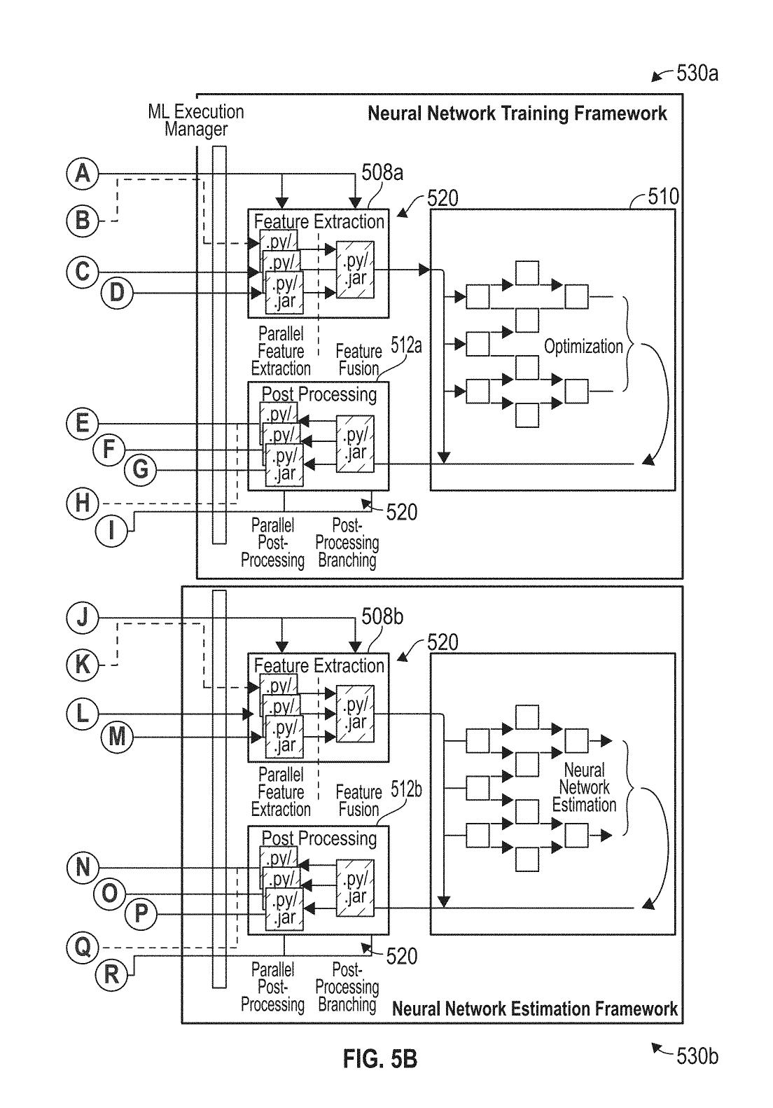

FIG. 6 illustrates a schematic of the computing device 108 in accordance with some embodiments. The computing device 108 can be any of the components described herein. As shown in at least FIGS. 2, 5A, and 5B, the computing device 108 can include various interfaces 602 to communicate with one or more compute nodes, neural networks, etc. For example, the interfaces 602 can include a network card used to establish an Ethernet connection with one or more compute nodes.

The computing device 108 can include processing circuitry 604 to perform functionalities and operations as described herein. It will be understood that any or all of the functions and operations performed by processing circuitry 604 can be executed with hardware, software, firmware, or any combination thereof. In some embodiments, processing circuitry 604 can comprise one or more processors or processing cores.

In addition, the computing device 108 can include instructions 606. The instructions 606 can be stored in a memory or other storage medium. The instructions 606, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, at least a part of one or more computer systems (e.g., a standalone, client or server computer system) or one or more processors of the computing device 108 may be configured by firmware or software (e.g., instructions 606), an application portion, or an application) as a module that operates to perform specified operations. In an example, the software may reside on at least one machine-readable medium. In an example, the software, when executed by the underlying hardware of the module, can include instructions 606 to cause the hardware to perform the specified operations.

While a machine-readable medium may include a single medium, the term “machine-readable medium” may include a single medium or multiple media (e.g., a centralized or distributed database, and/or associated caches and servers).

The term “machine-readable medium” may include any medium that is capable of storing, encoding, or carrying instructions 606 for execution by a machine (e.g., the computing device 108) and that cause the machine to perform any one or more of the techniques of the present disclosure, or that is capable of storing, encoding or carrying data structures used by or associated with such instructions. In other words, the processing circuitry 604 can include instructions and can therefore be termed a machine-readable medium in the context of various embodiments. Other non-limiting machine-readable medium examples may include solid-state memories, and optical and magnetic media. Specific examples of machine-readable media may include: non-volatile memory, such as semiconductor memory devices (e.g., Electrically Programmable Read-Only. Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 606 may further be transmitted or received over a communications network using a transmission medium utilizing any one of a number of transfer protocols (e.g., frame relay, Internet protocol (IP), TCP, user datagram protocol (UDP), hypertext transfer protocol (HTTP), etc.). Example communication networks may include a local area network (LAN), a wide area network (WAN), a packet data network (e.g., the Internet), mobile telephone networks ((e.g., channel access methods including Code Division Multiple Access (CDMA), Time-division multiple access (TDMA), Frequency-division multiple access (FDMA), and Orthogonal Frequency Division Multiple Access (OFDMA) and cellular networks such as Global System for Mobile Communications (GSM), Universal Mobile Telecommunications System (UMTS), CDMA 2000 1×* standards and Long Term Evolution (LIE)), Plain Old Telephone (POTS) networks, and wireless data networks (e.g., Institute of Electrical and Electronics Engineers (IEEE) 802 family of standards including IEEE 802.11 standards (WiFi), IEEE 802.16 standards (WiMax®) and others), peer-to-peer (P2P) networks, or other protocols now known or later developed.

The term “transmission medium” shall be taken to include any intangible medium that is capable of storing, encoding or carrying instructions for execution by hardware processing circuitry, and includes digital or analog communications signals or other intangible medium to facilitate communication of such software.

### Example Methods

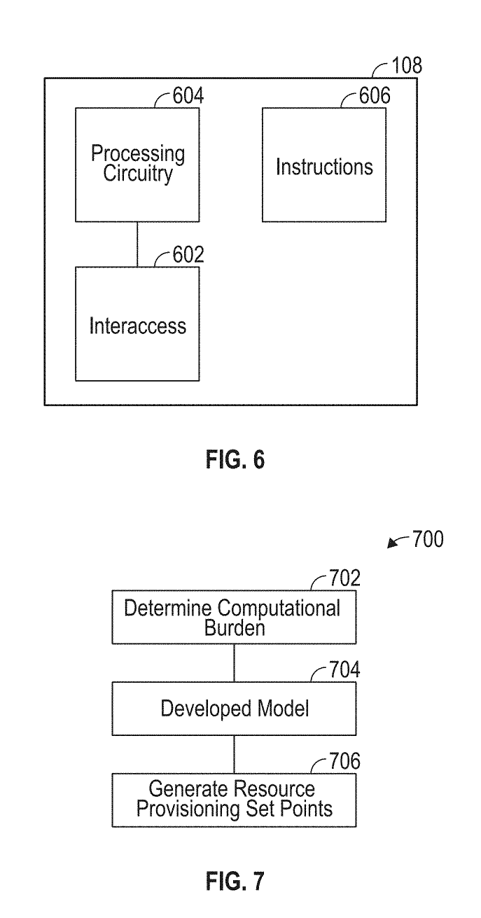

Various methods can be implemented in accordance with various embodiments to perform functions of usage models described above, as well as other usage models. FIG. 7 is a flow diagram of an example method 700 in accordance with some embodiments. A computer, for example the computing device 108, as described here or elements thereof, can perform operations of the example method 700. Accordingly, the example method 700 will be described with reference to components of FIGS. 1-6. For example, processing circuitry 604 can perform one or more operations of example method 700.

The example method 700 begins with operation 702 with the processing circuitry 108 can determine a computation burden for a component of an application. As described herein the computational burden can be for a component of the application executing at a specific performance level.

The example method 700 continues with operation 704 with the computing device 108 can develop a cost model. For example, and as discussed herein, the computing device 108 can utilized data and develop models that predict a cost for various resource allocations.

The example method 700 continues with operation 706 with the computing device generating resource provisioning set points. As discussed herein, the resource provisioning set points can indicate a quantity of compute nodes assigned for each phase of a component of an application. The quantity of the compute nodes can be based on the specified performance level and cost data.

### Additional Notes & Examples

Example 1 can include a computing device. The computing device can comprise a processor and a memory. The memory can store instructions that, when executed by the processor, cause the processor to perform operations. The operations can comprise: determining a computational burden for a component of an application, developing a cost model, and generating resource provisioning set points. The component of the application can be executed at a specified performance level. The cost model can specify a cost to execute the component of the application over a range of performance levels including the specified performance level. Each of the resource provisioning set points can indicate a quantity of compute nodes assigned for each phase of the component of the application. The quantity of compute nodes can be based on the specified performance level and the cost to execute the component of the application.

In Example 2, the computing device of Example 1 can optionally include the computational burden being determined theoretically.

In Example 3, the computing device of Example 1 can optionally include the computational burden being determined empirically.

In Example 4, the computing device of any one of or any combination of Examples 1-3 can optionally include the resource provisioning set points including control signals for dynamically adjusting the quantity of compute nodes.

In Example 5, the computing device of any one of or any combination of Examples 1-4 can optionally include the operations further comprising receiving data indicating a performance level of an execution of the component of the application.

In Example 6, the computing device of any one of or any combination of Examples 1-5 can optionally include the quantity of compute nodes being virtual compute nodes.

In Example 7, the computing device of any one of or any combination of Examples 1-5 can optionally include the quantity of compute nodes being physical compute nodes.

In Example 8, the computing device of any one of or any combination of Examples 1-5 can optionally include the quantity of compute nodes including virtual compute nodes and physical compute nodes.

In Example 9. the computing device of any one of or any combination of Examples 1-8 can optionally include the quantity of compute nodes being different for each phase of the component of the application.

In Example 10, the computing device of any one of or any combination of Examples 1-9 can optionally include the operations further comprising optimizing the resource provisioning set points based on a constraint provided by a user.

In Example 11, the computing device of Example 10 can optionally include the constraint provided by the user including a maximum execution time.

In Example 12, the computing device of any one of or any combination of Examples 10 and 11 can optionally include the constraint provided by the user including a maximum cost.

In Example 13, the computing device of any one of or any combination of Examples 10-12 can optionally include the constraint provided by the user including a maximum number of compute nodes.

In Example 14, the computing device of any one of or any combination of Examples 10-13 can optionally include optimizing the resource provisioning set points including minimizing a total cost to the user.

In Example 15, the computing device of any one of or any combination of Examples 10-13 can optionally include optimizing the resource provisioning set points including minimizing an execution time.

In Example 16, the computing device of any one of or any combination of Examples 1-15 can optionally include the operations further comprising: determining when a developer input has been received; utilizing a default plug-in when the developer input has not been received; and utilizing the developer input when the developer input has been received.

In Example 17, the computing device of any one of or any combination of Examples 1-16 can optionally include the operations further comprising merging a plurality of independently processed data streams before beginning a machine learning operation.

In Example 18, the computing device of Example 17 can optionally include the operations further comprising separating a post processed data stream from the machine learning operation into independently process-Ale blocks of data.

In Example 19, the computing device of any one of or any combination of Examples 1-18 can optionally include the operations further comprising performing simulations to determine a validity of the resource provisioning set points.

In Example 20, the computing device of any one of or any combination of Examples 1-19 can optionally include the operations further comprising receiving data describing a performance of the quantity of compute nodes under a plurality of resource allocations.

In Example 21, the computing device of Example 20 can optionally include the data describing the performance of the quantity of compute nodes being received via a data stream.

In Example 22, the computing device of Example 20 can optionally include the data describing the performance of the quantity of compute nodes being received via data logs.

In Example 23, the computing device of any one of or any combination of Examples 1-22 can optionally include the operations further comprising transmitting the resource provisioning set points to a machine learning application framework.

In Example 24, the computing device of any one of or any combination of Examples 1-22 can optionally include the quantity of compute nodes comprising a first set of compute nodes belonging to a first machine learning application framework and a second set of compute nodes belonging to a second machine learning application framework.

In Example 25, the computing device of any one of or any combination of Examples 1-24 can optionally include the operations further comprising generating a pictorial representation of the resource provisioning set points as a function of at least compute time and total cost.

Example 26 can include a computing system. The computing system can comprise a plurality of compute nodes and a user terminal. Each of the compute nodes can be configured to perform at least one phase of a component of an application. The user terminal can have processing circuitry. The processing circuity can be configured to: determine a computational burden for the component of the application, develop a cost model, generate resource provisioning set points, and transmit the resource provisioning set points to the plurality of compute nodes. The component of the application can execute at a specified performance level. The cost model can specify a cost to execute the component of the application over a range of performance levels including the specified performance level. Each of the resource provisioning set points can indicate a quantity of compute nodes from the plurality of compute nodes assigned for the at least one phase of the component of the application. The quantity of compute nodes can be based on the specified performance level and the cost to execute the component of the application.

In Example 27, the computing system of Example 26 can optionally include the plurality of compute nodes being part of a machine learning framework.

In Example 28, the computing system of Example 26 can optionally include a first set of the plurality of compute nodes being part of a first machine learning framework and a second set of the plurality of compute nodes being part of a second machine learning framework.

In Example 29, the computing system of any one of or any combination of Examples 26-28 can optionally include the computational burden being determined theoretically.

In Example 30, the computing system of any one of or any combination of Examples 26-28 can optionally include the computational burden being determined empirically.

In Example 31, the computing system of any one of or any combination of Examples 26-30 can optionally include the resource provisioning set points including control signals configured to dynamically adjust the quantity of compute nodes.

In Example 32, the computing system of any one of or any combination of Examples 26-30 can optionally include the quantity of compute nodes being virtual compute nodes.

In Example 33, the computing system of any one of or any combination of Examples 26-30 can optionally include the quantity of compute nodes being physical compute nodes.

In Example 34, the computing system of any one of or any combination of Examples 26-30 can optionally include the quantity of compute nodes including virtual compute nodes and physical compute nodes.

In Example 35, the computing system of any one of or any combination of Examples 26-34 can optionally include the quantity of compute nodes being different for each phase of the component of the application.

In Example 36, the computing system of any one of or any combination of Examples 26-35 can optionally include the processing circuitry being further configured to optimize the resource provisioning set points based on a constraint provided by a user.

In Example 37, the computing system of Example 36 can optionally include the constraint provided by the user including a maximum execution time.

In Example 38, the computing system of any one of or any combination of Examples 36 and 37 can optionally include the constraint provided by the user including a maximum cost.

In Example 39, the computing system of any one of or any combination of Examples 36-38 can optionally include the constraint provided by the user including a maximum number of compute nodes.

In Example 40, the computing system of any one of or any combination of Examples 36-39 can optionally include optimizing the resource provisioning set points including minimizing a total cost to the user.

In Example 41, the computing system of any one of or any combination of Examples 36-39 can optionally include optimizing the resource provisioning set points including minimizing an execution time.

In Example 42, the computing system of any one of or any combination of Examples 26-41 can optionally include the processing circuitry being further configured to: determine when a developer input has been received; utilize a default plug-in when the developer input has not been received; and utilize the developer input when the developer input has been received.

In Example 43, the computing system of any one of or any combination of Examples 26-42 can optionally include the processing circuitry being further configured to merge a plurality of independently processed data streams before beginning a machine learning operation.

In Example 44, the computing system of Example 43 can optionally include the processing circuity being further configured to separate a post processed data stream from the machine learning operation into independently process-able blocks of data.

In Example 45, the computing system of any one of or any combination of Examples 26-44 can optionally include the processing circuity being further configured to perform simulations to determine a validity of the resource provisioning set points.

In Example 46, the computing system of any one of or any combination of Examples 26-45 can optionally include the processing circuitry being further configured to receive data describing a performance of the plurality of compute nodes under a plurality of resource allocations.

In Example 47, the computing system of Example 46 can optionally include the data describing the performance of the plurality of compute nodes being received via a data stream.

In Example 48, the computing system of Example 46 can optionally include the data describing the performance of the plurality of compute nodes being received via data logs.

In Example 49, the computing system of any one of or any combination of Examples 26-48 can optionally include the processing circuitry being further configured to generate a pictorial representation of the resource provisioning set points as a function of at least compute time and total cost.

Example 50 can include a computing device. The computing device can comprise: means for determining a computational burden for a component of an application; means for developing a cost model; and means for generating resource provisioning set points. The component of the application can execute at a specified performance level. The cost model can specify a cost to execute the component of the application over a range of performance levels including the specified performance level. Each of the resource provisioning set points can indicate a quantity of compute nodes assigned for each phase of the component of the application. The quantity of compute nodes can be based on the specified performance level and the cost to execute the component of the application.

In Example 51, the computing device of Example 50 can optionally include computational burden being determined theoretically.

In Example 52, the computing device of Example 50 can optionally include the computational burden being determined empirically.

In Example 53, the computing device of any one of or any combination of Examples 50-52 can optionally include the resource provisioning set points including control signals for dynamically adjusting the quantity of compute nodes.

In Example 54, the computing device of any one of or any combination of Examples 50-53 can optionally include means for receiving data indicating a performance level of an execution of the component of the application.

In Example 55, the computing device of any one of or any combination of Examples 50-54 can optionally include the quantity of compute nodes being virtual compute nodes.

In Example 56, the computing device of any one of or any combination of Examples 50-54 can optionally include the quantity of compute nodes being physical compute nodes.

In Example 57, the computing device of any one of or any combination of Examples 50-54 can optionally include the quantity of compute nodes including virtual compute nodes and physical compute nodes.

In Example 58, the computing device of any one of or any combination of Examples 50-57 can optionally include the quantity of compute nodes being different for each phase of the component of the application.

In Example 59, the computing device of any one of or any combination of Examples 50-58 can optionally include means for optimizing the resource provisioning set points based on a constraint provided by a user.

In Example 60, the computing device of Example 59 can optionally include the constraint provided by the user including a maximum execution time.

In Example 61, the computing device of any one of or any combination of Examples 59 and 60 can optionally include the constraint provided by the user including a maximum cost.

In Example 62, the computing device of any one of or any combination of Examples 59-61 can optionally include the constraint provided by the user including a maximum number of compute nodes.

In Example 63, the computing device of any one of or any combination of Examples 59-62 can optionally include the means for optimizing the resource provisioning set points including means for minimizing a total cost to the user.

In Example 64, the computing device of any one of or any combination of Examples 59-62 can optionally include the means for optimizing the resource provisioning set points including means for minimizing an execution time.

In Example 65, the computing device of any one of or any combination of Examples 50-64 can optionally include: means for determining when a developer input has been received; means for utilizing a default plug-in when the developer input has not been received; and means for utilizing the developer input when the developer input has been received.

In Example 66, the computing device of any one of or any combination of Examples 50-65 can optionally include means for merging a plurality of independently processed data streams before beginning a machine learning operation.

In Example 67, the computing device of Example 66 can optionally include means for separating a post processed data stream from the machine learning operation into independently process-able blocks of data.

In Example 68, the computing device of any one of or any combination of Examples 50-67 can optionally include means for performing simulations to determine a validity of the resource provisioning set points.

In Example 69, the computing device of any one of or any combination of Examples 50-68 can optionally include means for receiving data describing a performance of the quantity of compute nodes under a plurality of resource allocations.

In Example 70, the computing device of any one of or any combination of Examples 50-69 can optionally include means for transmitting the resource provisioning set points to a machine learning application framework.

In Example 71, the computing device of any one of or any combination of Examples 50-69 can optionally include the quantity of compute nodes comprising a first set of compute nodes belonging to a first machine learning application framework and a second set of compute nodes belonging to a second machine learning application framework.

In Example 72, the computing device of any one of or any combination of Examples 50-71 can optionally include means for generating a pictorial representation of the resource provisioning set points as a function of at least compute time and total cost.

Example 73 can include at least one computer-readable medium. The at least one computer-readable medium can store instructions that, when executed by a processor, cause the processor to perform operations. The operations can comprise: determining a computational burden for a component of an application; developing a cost model; and generating resource provisioning set points. The component of the application can execute at a specified performance level. The cost model can specify a cost to execute the component of the application over a range of performance levels including the specified performance level. Each of the resource provisioning set points can indicate a quantity of compute nodes assigned for each phase of the component of the application. The quantity of compute nodes can be based on the specified. performance level and the cost to execute the component of the application.

In Example 74, the at least one computer-readable medium of Example 73 can optionally include the computational burden being determined theoretically.

In Example 75, the at least one computer-readable medium of Example 73 can optionally include the computational burden being determined empirically.

In Example 76, the at least one computer-readable medium of any one of or any combination of Examples 73-75 can optionally include the resource provisioning set points including control signals for dynamically adjusting the quantity of compute nodes.

In Example 77, the at least one computer-readable medium of any one of or any combination of Examples 73-76 can optionally include the operations further comprising receiving data indicating a performance level of an execution of the component of the application.

In Example 78, the at least one computer-readable medium of any one of or any combination of Examples 73-77 can optionally include the quantity of compute nodes being virtual compute nodes.

In Example 79, the at least one computer-readable medium of any one of or any combination of Examples 73-77 can optionally include the quantity of compute nodes being physical compute nodes.

In Example 80, the at least one computer-readable medium of any one of or any combination of Examples 73-77 can optionally include the quantity of compute nodes including virtual compute nodes and physical compute nodes.

In Example 81, the at least one computer-readable medium of any one of or any combination of Examples 73-80 can optionally include the quantity of compute nodes being different for each phase of the component of the application.

In Example 82, the at least one computer-readable medium of any one of or any combination of Examples 73-81 can optionally include the operations further comprising optimizing the resource provisioning set points based on a constraint provided by a user.

In Example 83, the at least one computer-readable medium of Example 82 can optionally include the constraint provided by the user including a maximum execution time.

In Example 84, the at least one computer-readable medium of any one of or any combination of Examples 82 and 83 can optionally include the constraint provided by the user including a maximum cost.

In Example 85, the at least one computer-readable medium of any one of or any combination of Examples 82-84 can optionally include the constraint provided by the user including a maximum number of compute nodes.

In Example 86, the at least one computer-readable medium of any one of or any combination of Examples 82-85 can optionally include optimizing the resource provisioning set points including minimizing a total cost to the user.

In Example 87, the at least one computer-readable medium of any one of or any combination of Examples 82-85 can optionally include optimizing the resource provisioning set points including minimizing an execution time.

In Example 88, the at least one computer-readable medium of any one of or any combination of Examples 73-87 can optionally include the operations further comprising: determining when a developer input has been received; utilizing a default plug-in when the developer input has not been received; and utilizing the developer input when the developer input has been received.

In Example 89, the at least one computer-readable medium of any one of or any combination of Examples 73-88 can optionally include the operations further comprising merging a plurality of independently processed data streams before beginning a machine learning operation.

In Example 90, the at least one computer-readable medium of Example 89 can optionally include the operations further comprising separating a post processed data stream from the machine learning operation into independently process-able blocks of data.

In Example 91, the at least one computer-readable medium of any one of or any combination of Examples 73-90 can optionally include the operations further comprising performing simulations to determine a validity of the resource provisioning set points.

In Example 92, the at least one computer-readable medium of any one of or any combination of Examples 73-91 can optionally include the operations further comprising receiving data describing a performance of the quantity of compute nodes under a plurality of resource allocations.

In Example 93, the at least one computer-readable medium of Example 92 can optionally include the data describing the performance of the quantity of compute nodes being received via a data stream.

In Example 94, the at least one computer-readable medium of Example 92 can optionally include the data describing the performance of the quantity of compute nodes being received via data logs.

In Example 95, the at least one computer-readable medium of any one of or any combination of Examples 73-94 can optionally include the operations further comprising transmitting the resource provisioning set points to a machine learning application framework.

In Example 96, the at least one computer-readable medium of any one of or any combination of Examples 73-94 can optionally include the quantity of compute nodes comprising a first set of compute nodes belonging to a first machine learning application framework and a second set of compute nodes belonging to a second machine learning application framework.

In Example 97, the at least one computer-readable medium of any one of or any combination of Examples 73-96 can optionally include the operations further comprising generating a pictorial representation of the resource provisioning set points as a function of at least compute time and total cost.

Example 98 can include a method. The method can comprise: determining, by a computing device comprising a processor, a computational burden for a component of an application; developing, by the computing device, a cost model; and generating, by the computing device, resource provisioning set points. The component of the application can execute at a specified performance level. The cost model can specify a cost to execute the component of the application over a range of performance levels including the specified performance level. Each of the resource provisioning set points can indicate a quantity of compute nodes assigned for each phase of the component of the application. The quantity of compute nodes can be based on the specified performance level and the cost to execute the component of the application.

In Example 99, the method of Example 98 can optionally include the computational burden being determined theoretically.

In Example 100, the method of Example 98 can optionally include the computational burden being determined empirically.

In Example 101, the method of any one of or any combination of Examples 98-100 can optionally include the resource provisioning set points including control signals for dynamically adjusting the quantity of compute nodes.

In Example 102, the method of any one of or any combination of Examples 98-101 can optionally include receiving data indicating a performance level of an execution of the component of the application.

In Example 103, the method of any one of or any combination of Examples 98-102 can optionally include the quantity of compute nodes being virtual compute nodes.

In Example 104, the method of any one of or any combination of Examples 98-103 can optionally include the quantity of compute nodes being physical compute nodes.

In Example 105, the method of any one of or any combination of Examples 98-104 can optionally include the quantity of compute nodes including virtual compute nodes and physical compute nodes.

In Example 106, the method of any one of or any combination of Examples 98-105 can optionally include the quantity of compute nodes being different for each phase of the component of the application.

In Example 107, the method of any one of or any combination of Examples 98-106 can optionally include optimizing the resource provisioning set points based on a constraint provided by a user.

In Example 108, the method of Example 107 can optionally include the constraint provided by the user including a maximum execution time.

In Example 109, the method of any one of or any combination of Examples 107 and 108 can optionally include the constraint provided by the user including a maximum cost.

In Example 110, the method of any one of or any combination of Examples 107-109 can optionally include the constraint provided by the user including a maximum number of compute nodes.

In Example 111, the method of any one of or any combination of Examples 107-110 can optionally include optimizing the resource provisioning set points including minimizing a total cost to the user.

In Example 112, the method of any one of or any combination of Examples 107-110 can optionally include optimizing the resource provisioning set points including minimizing an execution time.

In Example 113, the method of any one of or any combination of Examples 98-112 can optionally include: determining when a developer input has been received; utilizing a default plug-in when the developer input has not been received; and utilizing the developer input when the developer input has been received.

In Example 114, the method of any one of or any combination of Examples 98-113 can optionally include merging a plurality of independently processed data streams before beginning a machine learning operation.

In Example 115, the method of Example 114 can optionally include separating a post processed data stream from the machine learning operation into independently process-able blocks of data.

In Example 116, the method of any one of or any combination of Examples 98-115 can optionally include performing simulations to determine a validity of the resource provisioning set points.

In Example 117, the method of any one of or any combination of Examples 98-116 can optionally include receiving data describing a performance of the quantity of compute nodes under a plurality of resource allocations.

In Example 118, the method of Example 117 can optionally include the data describing the performance of the quantity of compute nodes being received via a data stream.

In Example 119, the method of Example 117 can optionally include the data describing the performance of the quantity of compute nodes being received via data logs.

In Example 120, the method of any one of or any combination of Examples 98-119 can optionally include transmitting the resource provisioning set points to a machine learning application framework.

In Example 121, the method of any one of or any combination of Examples 98-119 can optionally include the quantity of compute nodes comprising a first set of compute nodes belonging to a first machine learning application framework and a second set of compute nodes belonging to a second machine learning application framework.

In Example 122, the method of any one of or any combination of Examples 98-121 can optionally include generating a pictorial representation of the resource provisioning set points as a function of at least compute time and total cost.

Example 123 can include at least one machine-readable medium including instructions, which when executed by a machine, cause the machine to perform operations of any of the methods of Examples 98-122.

Example 124 can include an apparatus comprising means for performing any of the methods of Examples 98-122.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. However, the claims may not set forth features disclosed herein because embodiments may include a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A computing device comprising:
a processor; and
a memory storing instructions that, when executed by the processor, cause the processor to perform operations comprising:
determining a computational burden for a component of an application, the component of the application executing at a specified performance level;
developing a cost model, the cost model specifying a cost to execute the component of the application over a range of performance levels including the specified performance level; and
generating resource provisioning set points, each of the resource provisioning set points indicating a quantity of compute nodes assigned for each phase of the component of the application, the quantity of compute nodes based on the specified performance level and the cost to execute the component of the application.

2. The computing device of claim 1, wherein the resource provisioning set points include control signals for dynamically adjusting the quantity of compute nodes.

3. The computing device of claim 1, wherein the operations further comprise receiving data indicating a performance level of an execution of the component of the application.

4. The computing device of claim 1, wherein the quantity of compute nodes is different for each phase of the component of the application.

5. The computing device of claim 1, wherein the operations further comprise optimizing the resource provisioning set points based on a constraint provided by a user.

6. The computing device of claim 5, wherein the constraint provided by the user includes a maximum execution time.

7. The computing device of claim 1, wherein the operations further comprise merging a plurality of independently processed data streams before beginning a machine learning operation.

8. The computing device of claim 7, wherein the operations further comprise separating a post processed data stream from the machine learning operation into independently process-able blocks of data.

9. The computing device of claim 1, wherein the operations further comprise performing simulations to a validity of the resource provisioning set points.

10. The computing device of claim 1, wherein the operations further comprise receiving data describing a performance of the quantity of compute nodes under a plurality of resource allocations.

11. The computing device of claim 1, wherein the operations further comprise transmitting the resource provisioning set points to a machine learning application framework.

12. The computing device of claim 1, wherein the operations further comprise generating a pictorial representation of the resource provisioning set points as a function of at least compute time and total cost.

13. A method for providing a structure machine learning framework, the method comprising:
determining, by a computing device comprising a processor, a computational burden for a component of an application, the component of the application executing at a specified performance level;
developing, by the computing device, a cost model, the cost model specifying a cost to execute the component of the application over a range of performance levels including the specified performance level; and
generating, by the computing device, resource provisioning set points, each of the resource provisioning set points indicating a quantity of compute nodes assigned for each phase of the component of the application, the quantity of compute nodes based on the specified performance level and the cost to execute the component of the application.

14. The method of claim 13, wherein the resource provisioning set points include control signals for dynamically adjusting the quantity of compute nodes.

15. The method of claim 13, further comprising optimizing the resource provisioning set points based on a constraint provided by a user.

16. The method of claim 13, further comprising generating a pictorial representation of the resource provisioning set points as a function of at least compute time and total cost.

17. At least one computer-readable medium storing instructions for providing a structure machine learning framework that, when executed by a processor, cause the processor to perform operations comprising:
determining a computational burden for a component of an application, the component of the application executing at a specified performance level;
developing a cost model, the cost model specifying a cost to execute the component of the application over a range of performance levels including the specified performance level; and
generating resource provisioning set points, each of the resource provisioning set points indicating a quantity of compute nodes assigned for each phase of the component of the application, the quantity of compute nodes based on the specified performance level and the cost to execute the component of the application.

18. The at least one computer-readable medium of claim 17, wherein the resource provisioning set points include control signals for dynamically adjusting the quantity of compute nodes.

19. The at least one computer-readable medium of claim 17, wherein the operations further comprise optimizing the resource provisioning set points based on a constraint provided by a user.

20. The at least one computer-readable medium of claim 17, wherein the operations further comprise transmitting the resource provisioning set points to a machine learning application framework.

21. The at least one computer-readable medium of claim 17, wherein the operations further comprise generating a pictorial representation of the resource provisioning set points as a function of at least compute time and total cost.
